(19) United States
(12) Patent Application Publication
(10) Pub. No.: US 2007/0052906 A1
(43) Pub. Date: Mar. 8, 2007

(54) Electronic device and manufacturing method thereof

(75) Inventor: Akira Sueyoshi, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD, Kyoto (JP)

(21) Appl. No.: 10/575,811

(22) PCT Filed: Oct. 15, 2004
(86) PCT No.: PCT/JP04/15230

§ 371 Date: Apr. 14, 2006

(30) Foreign Application Priority Data
Oct. 16, 2003 (JP) 2003-356220

(51) Int. Cl. G02F 1/1345

(52) U.S. Cl. 349/151

(57) ABSTRACT

An electronic device (A1) is a liquid crystal display incorporated in a mobile phone, for example. The electronic device (A1) an IC chip (3) mounted on the rear surface of a base plate (1A), and a light shielding tape (41) for preventing incidence of light to the IC chip (3). The light shielding tape (41) is provided with an indication of information (51) regarding the electronic device (A1). The information (51) is a lot number of the electronic device (A1), for example. Thus, the light shielding tape (41) has two functions, i.e. a light shielding function and an information displaying function.

### TECHNICAL FIELD

The present invention relates to an electronic device provided with an IC chip. The present invention further relates to a manufacturing method of such an electronic device.

### BACKGROUND ART

An example of conventional electronic device provided with an IC chip is a liquid crystal display. FIG. 7 of the present application is a sectional view illustrating a principal part of a liquid crystal display (indicated by a reference character X1) disclosed in Patent document 1 listed below. The liquid crystal display X1 includes a pair of transparent base plates 101A, 101B and a liquid crystal portion 102 sandwiched between the base plates. The liquid crystal display X1 further includes a drive IC chip 103 and a light shielding tape 104. The drive IC chip 103 is mounted on the upper surface of the base plate 101A, while the light shielding tape 104 is attached to the lower surface of the base plate 101A. As shown in FIG. 7, the light shielding tape 104 is positioned immediately below the drive IC chip 103.

Due to the structure shown in FIG. 7, light traveling from below toward the drive IC chip 103 is interrupted by the light shielding tape 104. Thus, the drive IC chip 103 is prevented from malfunctioning due to incident of the light.

Next, description is made with reference to FIG. 8 of the present application. The figure illustrates a liquid crystal display (indicated by a reference character X2) disclosed in Patent document 2 listed below. The liquid crystal display X2 includes a base plate 101A made of glass (or a synthetic resin), and the upper surface of the base plate is provide with an indication 105, such as a lot number, for manufacturing control. The conventional indication 105 can be formed on the base plate 101A utilizing e.g. a laser marking device.

Patent Document 1: JP-A-H06-112371

Patent Document 2: JP-A-2002-303843

Recently, the liquid crystal display is desired to reduce the overall size of the liquid crystal panel, while increasing the imaged is play area. This holds for a liquid crystal display incorporated in a mobile phone, for example. However, the above-described liquid crystal display X2 has difficulty in meeting the requirement. The reason is as follows. As described above, the base plate 101A of the liquid crystal display X2 is provided with the manufacturing control indication 105, and the image display area need be formed at a portion where the indication. 105 is not provided. Thus, the size of the image display area is smaller than when the indication 105 is not provided.

The problem of the reduced image display area is more serious when the indication for manufacturing control is provided on the lower surface of the base plate 101A shown in FIG. 7. Specifically, the indication for manufacturing control needs to be provided on a portion that is not covered by the light shielding tape 104, so that the indication is visible. Thus, the image display area is formed at a portion where neither of the light shielding tape 104 nor the indication for manufacturing control is provided. As a result, the size of the image display area may be much smaller than when only the indication for manufacturing control is provided.

Another problem of the liquid crystal display X2 is that the production equipment is expensive. In the liquid crystal display X2, the indication 105 for manufacturing control is formed directly on the base plate 101A made of glass or a synthetic resin. For implementing the marking properly, it is necessary to use a special marking device. Such a marking device, however, is more expensive than a general-purpose printing device or a stamper.

### DISCLOSURE OF THE INVENTION

The present invention has been proposed under the above-described circumstances. It is therefore an object of the present invention to provide a technique for downsizing an electronic device, and for enabling inexpensive but proper indication of information.

An electronic device according to a first aspect of the present invention comprises an IC chip, and a light shielding member for preventing incidence of light to the IC chip. Information regarding the electronic device is indicated on the light shielding member.

Preferably, the electronic device of the present invention may further comprise an image display area controlled by the IC chip.

Preferably, the electronic device of the present invention may further comprise a transparent base plate that includes a first surface on which the IC chip is mounted and a second surface opposite to the first surface. At least a part of the light shielding member is attached to the second surface.

Preferably, the electronic device of the present invention may further comprise a wiring connecting member connected to the base plate. The light shielding member is attached to both of the base plate and the wiring connecting member.

Preferably, the light shielding member may be dark in color, and ink used for indicating the above-mentioned information is also a dark color having different lightness from the light shielding member.

Preferably, the information may be indicated by a code symbol.

A method of manufacturing an electronic device according to a second embodiment of the present invention may comprise the steps of: attaching a light shielding member to a base plate for preventing incidence of light to an IC chip mounted on the base plate; and printing desired information on the light shielding member. The printing of the information is performed prior to the attaching of the light shielding member to the base plate.

### BRIEF DESCRIPTION OF THE DRAWINGS

FIG. 1 is an overall view of a liquid crystal display according to a first embodiment of the present invention.

FIG. 2 is a sectional view illustrating a principal part of FIG. 1 taken along II-II lines.

FIG. 3 illustrates a manufacturing method of the liquid crystal display.

FIG. 4 is an overall view of a liquid crystal display according to a second embodiment of the present invention.

FIG. 5 is a sectional view illustrating a principal part of FIG. 4 taken along V-V lines.

FIG. 6 is an overall view of a liquid crystal display according to a third embodiment of the present invention.

FIG. 7 is a sectional view illustrating a principal part of a conventional liquid crystal display.

FIG. 8 illustrates another conventional liquid crystal display.

### BEST MODE FOR CARRYING OUT THE INVENTION

Preferred embodiments of the present invention are specifically described below with reference to the accompanying drawings.

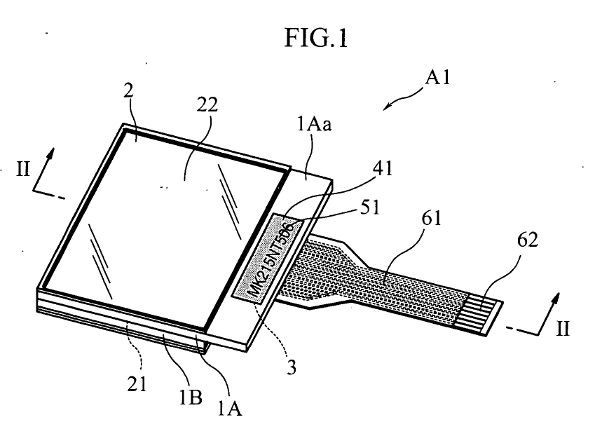

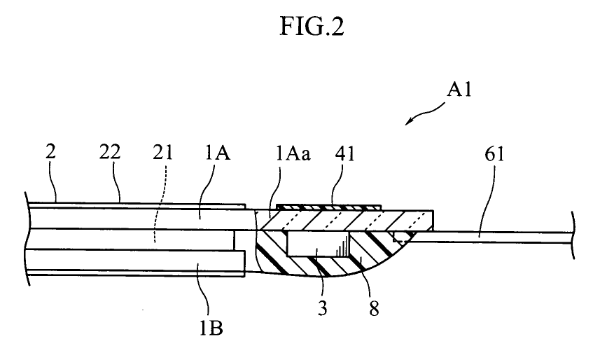

FIGS. 1 and 2 illustrate an electronic device according to a first embodiment of the present invention. The illustrated electronic device is a liquid crystal display (indicated by a reference character Al as a whole), but it should be appreciated that the present invention is not limited to this particular example. Other examples of the electronic device to which the present invention is applied include an organic EL display and a plasma display. Further, as it will be apparent from the following description, the present invention is applicable, not only to the displays, but also to other electronic devices provided with an IC chip.

As shown in FIGS. 1 and 2, the liquid crystal display Al includes a liquid crystal panel 2, a drive IC chip 3, a light shielding tape 41, and a flexible wiring board 61. The liquid crystal display Al is incorporated in e.g. a mobile phone.

The liquid crystal panel 2 includes a first transparent base plate 1A, a second transparent base plate 1B, a liquid crystal portion 21, and an image display area 22. The first and second base plates 1A, 1B are rectangular insulating plates that may be made of acrylic resin or glass. The liquid crystal portion 21 is formed by sandwiching a liquid crystal material between the first base plate 1A and the second base plate 1B. The image display area 22 is provided on the upper surface of the first base plate 1A.

The drive IC chip 3 controls the image display area 22 to display desired images. As shown in FIG. 2, the first base plate 1A includes an extension 1Aa horizontally extending beyond the second base plate 1B. The drive IC chip 3 is provided on the lower surface of the extension 1Aa. (Generally, the technique for mounting an IC chip directly on a glass base plate is called “chip-on-glass”.) The drive IC chip 3 is sealed in a light-shielding resin portion 8. The resin portion 8 is a dark color such as black, for example.

The light shielding tape 41 is a rectangular laminated film that is flexible and configured to shield light. The laminated film includes a base sheet (made of e.g. polyester) and polyvinyl fluoride film laminated on one surface of the base sheet. As shown in FIG. 1, on the upper surface of the light shielding tape 41, an identification mark (such as a lot number) 51 of the liquid crystal display is printed. The upper surface of the light shielding tape 41 is made e.g. dark gray, to shield light traveling toward the drive IC chip 3. On the other hand, the ink used for printing the identification mark 51 is a color with lower lightness than the upper surface of the light shielding tape 41 (an example of such a color is black). Preferably, the upper surface of the light shielding tape 41 is subjected to a treatment for providing hydrophilic properties, such as corona discharge and the like. In this way, the ink for printing the identification mark properly sticks to the upper surface of the tape.

The flexible wiring board 61 is for electric power supply and for input-output of signals relative to the drive IC chip 3. The flexible wiring board 61 includes a resin base film, a coverlay film, and a wiring pattern sandwiched between the two films. As shown in FIG. 1, the flexible wiring board 61 is elongated and includes a first end connected to the first base plate 1A and a second end positioned opposite to the first end. The second end is connected to a connector 62.

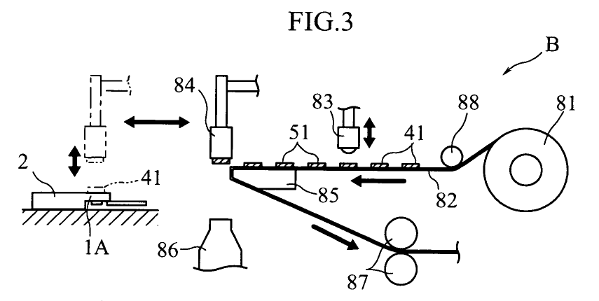

Next, a manufacturing method of the liquid crystal display A1 is described below with reference to FIG. 3. As shown in the figure, the manufacturing method utilizes a labeling device B for attaching the light shielding tape 41 to the liquid crystal panel 2. The labeling device B includes a supply reel 81 provided with a rolled strip-shaped sheet 82, and also includes a pair of drive rollers 87. As seen from FIG. 3, the drive rollers 87 are rotated in a predetermined direction so that the strip-shaped sheet 82 is pulled out from the supply reel 81. Further, the labeling device B includes a guide roller 88 for guiding the pulled out strip-shaped sheet 82, and also includes a turn-around member 85 for changing the traveling direction of the strip-shaped sheet 82.

In the example illustrated in FIG. 3, a sheet transfer path from the guide roller 88 to the turn-around member 85 extends horizontally (the transfer path is called as “horizontal path” hereafter). On the other hand, a sheet transfer path from the turn-around member 85 to the drive rollers 87 is not horizontal, but inclined at a predetermined angle. Of course, the above structure is only an example, and the present invention is not limited to this.

On one surface of the strip-shaped sheet 82, a plurality of light shielding tapes 41 are removably attached. These light shielding tapes 41 are spaced from each other at a predetermined distance, lengthwise of the strip-shaped sheet 82. The labeling device B is provided with a movable head 84 for removing the light shielding tape 41 from the strip-shaped sheet 82 one by one, and for attaching the tape to the liquid crystal panel 2.

As shown in FIG. 3, above the “horizontal transfer path”, a stamp printing mechanism 83 is provided. The stamp printing mechanism 83 is vertically movable, and prints an identification mark such as a lot number on each of the light shielding tapes 41 transferred by the strip-shaped sheet 82. After printing, the light shielding tape 41 is transferred to the left side in the figure, and arrives the turn-around member 85. The turn-around member 85 includes two surfaces, i.e. a horizontal upper surface and a vertical left end surface, with which the strip-shaped sheet 82 comes into contact. The strip-shaped sheet 82 is drastically folded when moving from the upper surface to the left end surface. In such an instance, the light shielding tape 41 is partly removed from the strip-shaped sheet 82. Here, the movable head 84 vacuums up and removes the entire light shielding tape 41 from the strip-shaped sheet 82, and holds the tape. Preferably, as shown in FIG. 3, a blower 86 is provided below the turn-around member 85. The blower 86 generates an upward air stream. Due to the air stream, the light shielding tape 41 tends to be turned over on the strip-shaped sheet 82, whereby the light shielding tape 41 can be reliably removed.

After the movable head 84 removes the light shielding tape 41 from the strip-shaped sheet 82, the movable head 84 moves to the liquid crystal panel 2 and attach the light shielding tape 41 to the first base plate 1A of the liquid crystal panel 2. For this process, the rear surface of the light shielding tape 41 is provided with an adhesive in advance, for example. Due to the adhesive, the light shielding tape 41 can be easily attached to the first base plate 1A.

In the above-described embodiment, the identification mark is not directly provided on the first base plate 1A of the liquid crystal panel 2, but is printed on the light shielding tape 41. In this way, the identification mark can be easily provided regardless of the material of the first base plate 1A. The identification mark is printed before the light shielding tape 41 is attached to the first baseplate 1A. Thus, the electronic components of the liquid crystal panel 2 are prevented from being damaged during the printing. As described above, the upper surface of the light shielding tape 41 is preferably treated with corona discharge or other hydrophile treatment. Therefore, the ink used for printing the identification mark properly stick onto the upper surface of the light shielding tape 41, whereby an inexpensive stamp printing mechanism can be utilized to provide the identification mark.

Further, in the above-described embodiment, while one light shielding tape 41 is printed, another light shielding tape 41 can be attached to the liquid crystal panel 2. Thus, the manufacturing efficiency is improved and the product cost of the liquid crystal display A1 can be reduced. In the above embodiment, the identification mark and the upper surface of the light shielding tape on which the identification mark is printed are both dark colors (with different lightness so that the identification mark can be read at least). In this way, the identification mark can be visible regardless of the thickness of the ink used for printing the identification mark. This is because the difference in brightness of the printing ink due to its uneven thickness is less distinguished than in the case where the upper surface of the light shielding tape is not a dark color.

Still further, in the above-described embodiment, the light shielding tape 41 prevents light incident into the drive IC chip 3 and also indicates the identification mark. Thus, the liquid crystal panel 2 needs no space for indicating the identification mark in addition to the portion provided with the light shielding tape 41. As a result, the image display area 22 can cover a large space, while reducing the entire size of the liquid crystal panel 2.

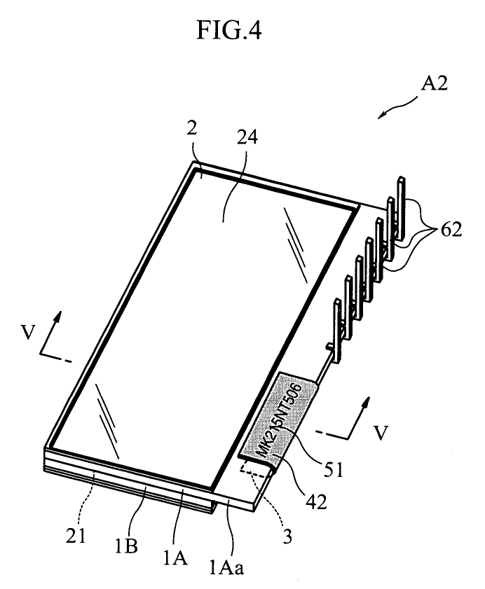

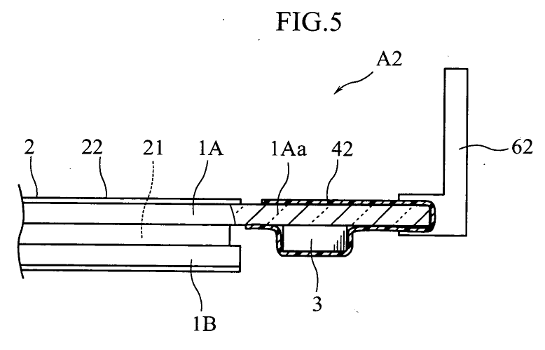

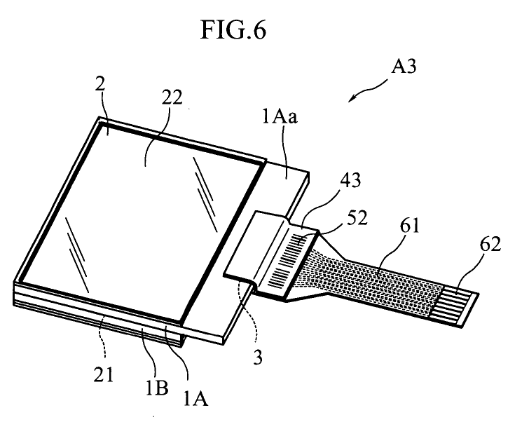

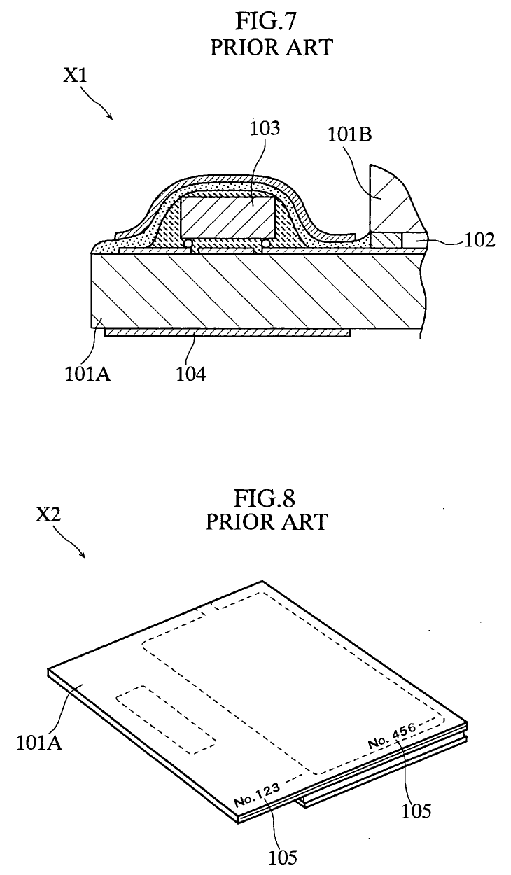

FIGS. 4 and 5 illustrate a liquid crystal display A2 according to a second embodiment of the present invention, and FIG. 6 illustrates a liquid crystal display A3 according to a third embodiment of the present invention. In these figures, elements identical or similar to those in the first embodiment are given the same reference characters as in the first embodiment.

The liquid crystal display A2 according to the second embodiment includes a light shielding tape 42 attached not only on the upper surface of the first base plate 1A, but also on its one side surface and the lower surface. As shown in FIG. 5, the light shielding tape 42 directly covers the drive IC chip 3 provided on the lower surface of the first base plate 1A. Further, the liquid crystal display A2 is provided with a plurality of lead pins 62 serving as electrode terminals. Thus, the flexible wiring board 61 used in the liquid crystal display A1 according to the first embodiment is not provided at the liquid crystal display A2.

Due to the structure shown in FIG. 5, the light shielding tape 42 prevents not only the light from above the drive IC chip 3, but also the light from below the drive IC chip 3. Thus, the light-shielding resin (see the reference number 8 in FIG. 2) covering the drive IC chip 3 is not needed to be provided in addition to the light shielding tape 42, thereby improving the manufacturing efficiency and reducing the product cost.

The liquid crystal display A3 shown in FIG. 6 includes a light shielding tape 43 positioned on both of the first base plate 1a and the flexible wiring board 61. On the upper surface of the light shielding tape 43, information regarding the liquid crystal display A3 is indicated by a code symbol 52. In the illustrated example, the code symbol 52 is a bar code (one-dimensional code), though the present invention is not limited to this. For example, in place of the bar code, use may be made of two-dimensional codes such as QR code (registered trademark) or DataMatrix (registered trademark).

In use of the code symbol 52, more information can be indicated than using numbers and alphabets (see FIG. 1). For example, in place of lot numbers, records (e.g. manufacturing plant, or shipping date) of the liquid crystal display A3 can be indicated. Further, the information can be read easily and quickly by e.g. code reader.

Further, according to the third embodiment, the flexible wiring board 61 is reinforced by the light shielding tape 43 at the portion provided with the light shielding tape 43. Thus, the flexible wiring board 61 is prevented from being broken due to an excess bending force at the portion provided with the tape. Still further, as the light shielding tape 43 is attached across the first base plate 1A and the flexible wiring board 61, the light shielding tape 43 has a large space and thus being capable of indicating much information. In the example shown in FIG. 6, the code symbol 52 is printed on the light shielding tape 43 only at a portion positioned on the flexible wiring board 61. However, according to the present invention, additional information may be printed on the light shielding tape 43 at a portion positioned on the extension 1Aa.

According to the present invention, the flexible light shielding tapes 41-43 may be replaced with light shielding means made of a less flexible plate material. The light shielding means is not limited to be a rectangle, but may be another form such as an ellipse.

In place of the stamp printing mechanism, a printer such as an ink-jet printer may be used to indicate the information on the light shielding means. The surface of the light shielding means and the ink for printing the information on the surface are preferably dark colors to improve the visibility of the information. However, either of the surface of the light shielding means and the ink may be a bright color, and the other may be a dark color.

1. An electronic device comprising:
an IC chip; and
a light shielding member for preventing incidence of light to the IC chip;
wherein the light shielding member is provided with an indication of information regarding the electronic device.

2. The electronic device according to claim 1, further comprising an image display area controlled by the IC chip.

3. The electronic device according to claim 1, further comprising a transparent base plate that includes a first surface on which the IC chip is mounted and a second surface opposite to the first surface,
wherein at least a part of the light shielding member is attached to the second surface.

4. The electronic device according to claim 3, further comprising a wiring connecting member connected to the base plate;
wherein the light shielding member is attached to both the base plate and the wiring connecting member.

5. The electronic device according to claim 1, wherein the light shielding member is a dark color, and the information is indicated with ink of a dark color different in lightness from the light shielding member.

6. The electronic device according to claim 1, wherein the information is indicated by a code symbol.

7. A method of manufacturing an electronic device, the method comprising the steps of: attaching a light shielding member to a base plate for preventing incidence of light to an IC chip mounted on the base plate; and printing desired information on the light shielding member;
wherein the printing of the information is performed prior to the attaching of the light shielding member.
